(19) United States
(12) Patent Application Publication
(10) Pub. No.: US 2017/0039582 A1
(43) Pub. Date: Feb. 9, 2017

(54) ANALYTIC DATA CAPTURING AND PROCESSING SYSTEM AND METHOD

(71) Applicant: EVENTLINK LLC, STERLING HEIGHTS, MI (US)

(72) Inventors: NEAL D. WELBOURNE, BEVERLY HILLS, MI (US); KEVIN D. OTIS, ROCHESTER, MI (US); BRADFORD DUNCAN MERRITT, FERNDALE, MI (US)

(21) Appl. No.: 15/228,437

(22) Filed: Aug. 4, 2016

Related U.S. Application Data
(60) Provisional application No. 62/200,883, filed on Aug. 4, 2015.

(51) Int. Cl. G06Q 30/02; G06F 17/30; H04L 12/26; H04L 29/08; H04L 29/12; H04W 4/02

(52) U.S. Cl. CPC G06Q 30/0205; H04L 61/6022; H04W 4/02; H04L 43/04; H04W 4/021; H04L 67/02; H04L 67/146; G06Q 30/0226; G06F 17/30241

(57) ABSTRACT

An analytic data capturing and processing system and method are disclosed. The system can include a data collection subsystem including at least one wireless access point for capturing wireless hardware addresses and timestamps and location data from a plurality of mobile devices. A processing subsystem can couple to the data collection subsystem. A storage subsystem may couple to the data collection subsystem and to the processing subsystem for storing the data collected. The data collection subsystem can be configured to capture website data associated with the plurality of mobile devices. The processing subsystem may be configured to scrub and analyze the wireless hardware addresses and timestamps and location data and website data captured to align mobile traffic information and website traffic information and foot traffic information.

### CROSS REFERENCE TO RELATED APPLICATION

This application claims the benefit of U.S. Provisional Application Ser. No. 62/200,883 tiled Aug. 4, 2015, which is incorporated herein by reference in its entirety.

### BACKGROUND

1. Field

The present disclosure relates to an analytic data capturing and processing system and method.

2. Description of the Prior Art

This section provides background information related to the present disclosure which is not necessarily prior art.

Consumers frequently use mobile devices for product research prior to purchasing a product. Mobile devices generally include the capability of communicating using one or more wireless technologies (e.g. Wi-Fi, Bluetooth, near field communication, etc.). Certain age groups additionally use mobile devices such as phones and tablets almost exclusively as a means to communicate and socialize and therefore may be more prone to use their mobile devices to research products and/or make purchases.

Analytic data capturing and processing systems are commonly used for marketing purposes to track, record, and analyze existing and potential customers' behaviors. The data collected is often rich with useful information; however, many existing systems and methods currently available are not always capable of capturing and processing the data in a form that is most useful to an end user. Additionally, known analytic data capturing and processing systems often do not take into account other available data that can augment captured data. Accordingly, there is an increasing need for improved analytic data capturing and processing systems and methods.

### SUMMARY

This section provides a general summary of the present disclosure and is not a comprehensive disclosure of its full scope or all of its features and advantages.

Accordingly, it is an aspect of the present disclosure to provide an analytic data capturing and processing system. The analytic data capturing and processing system can include a data collection subsystem including at least one wireless access point for capturing wireless hardware addresses and timestamps and location data from a plurality of mobile devices. A processing subsystem can couple to the data collection subsystem. A storage subsystem may couple to the data collection subsystem and to the processing subsystem. The storage subsystem can include at least one database for storing data from at least one of the data collection subsystem and the processing subsystem. The data collection subsystem can be configured to capture website data associated with the plurality of mobile devices. The processing subsystem may be configured to scrub and analyze the wireless hardware addresses and timestamps and location data and website data captured to align mobile traffic information and website traffic information and foot traffic information.

According to yet another aspect of the disclosure, a method of capturing and processing analytic data is provided. The method can include the step of capturing wireless hardware addresses and timestamps and location data from a plurality of mobile devices. Next, capturing website data associated with the plurality of mobile devices. The method then may proceed by enhancing the data captured by adding fields. The next step can include preparing the data for analysis. Then, the method can continue by joining the data to create a single source of lead generation. The method next includes the step of enhancing the data by appending demographics data. The method can conclude by storing the enhanced data in a database.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a block diagram of an analytic data capturing and processing system according to an aspect of the disclosure;

FIG. 2 illustrates a wireless access point of an analytic data capturing and processing system according to an aspect of the disclosure;

FIG. 3 illustrates the wireless access point of FIG. 2;

FIG. 4 is a diagram illustrating a plurality of wireless access points of an analytic data capturing and processing system according to an aspect of the disclosure;

FIG. 5 is a diagram illustrating the flow of data through an analytic data capturing and processing system according to an aspect of the disclosure;

FIG. 6 illustrates a display of an output subsystem of an analytic data capturing and processing system according to an aspect of the disclosure;

FIG. 7 is a flowchart of an analytic data capturing and processing method according to an aspect of the disclosure;

FIG. 8 is a diagram illustrating a predetermined area with geofenced areas according to an aspect of the disclosure; and

FIG. 9 is a diagram illustrating the data captured by an analytic data capturing and processing system according to an aspect of the disclosure.

### DETAILED DESCRIPTION

In the following description, details are set forth to provide an understanding of the present disclosure. In some instances, certain systems, structures and techniques have not been described or shown in detail in order not to obscure the disclosure.

In general, the present disclosure relates to an analytic data capturing and processing system and method. The analytic data capturing and processing system and method of this disclosure will be described in conjunction with one or more example embodiments. However, the specific example embodiments disclosed are merely provided to describe the inventive concepts, features, advantages and objectives will sufficient clarity to permit those skilled in this art to understand and practice the disclosure.

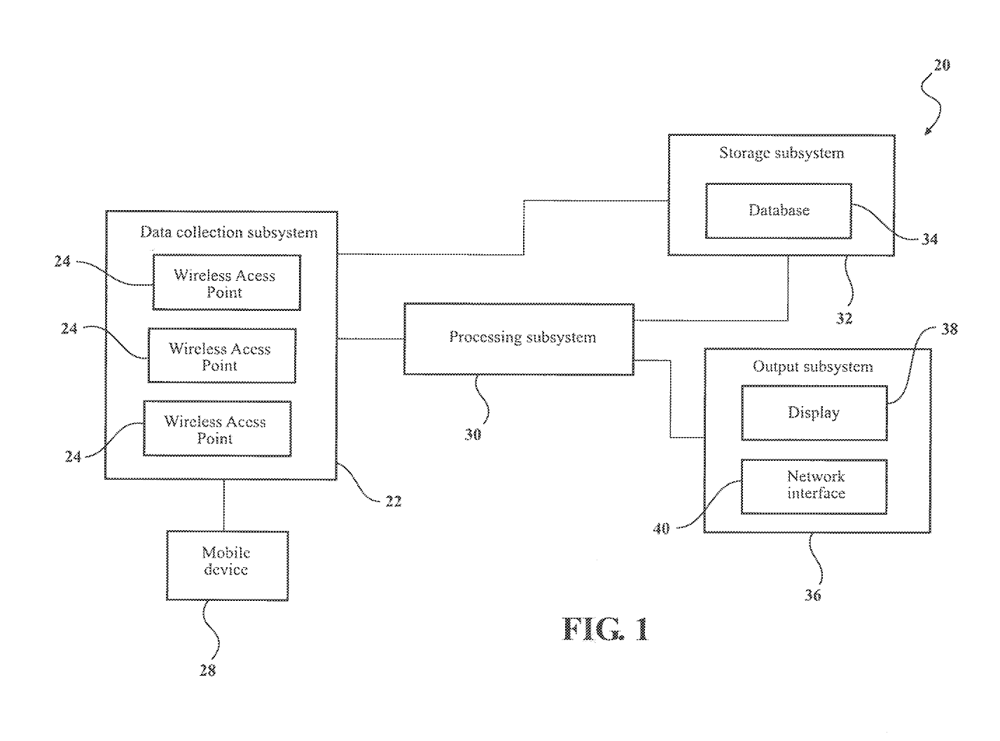

Referring to the Figures, wherein like numerals indicate corresponding parts throughout the several views, an analytic data capturing and processing method and system constructed in accordance with aspects of the disclosure is disclosed. As best shown in FIG. 1, the analytic data capturing and processing system 20 can include a data collection subsystem 22 including at least one wireless access point 24 for capturing wireless hardware addresses and timestamps and location data from a plurality of mobile devices 28 in a predetermined area 26. A processing subsystem 30 can couple to the data collection subsystem 22. A storage subsystem 32 may couple to the data collection subsystem 22 and to the processing subsystem 30. The storage subsystem 32 can include at least one database 34 for storing data from at least one of the data collection subsystem 22 and the processing subsystem 30. The data collection subsystem 22 can also be configured to capture website data associated with the plurality of mobile devices 28. The processing subsystem 30 may be configured to scrub and analyze the wireless hardware addresses and timestamps and location data and website data captured (e.g., wireless hardware addresses, timestamps, location data, and website data from the plurality of mobile devices 28) to align mobile traffic information and website traffic information and foot traffic information.

The analytic data capturing and processing system 20 can be configured to track this mobile traffic information and website traffic information and foot traffic information (i.e., key performance indicators) such as, but not limited to number of total and new and unique attendees, event zoning and aggregate analytics, average zone dwell time spent, zone engagement, conversion rates, attendance rate, event loyalty rate, total number of impressions, event geography, quality of event staff and participation, time of year, time of day, and event site plan analysis.

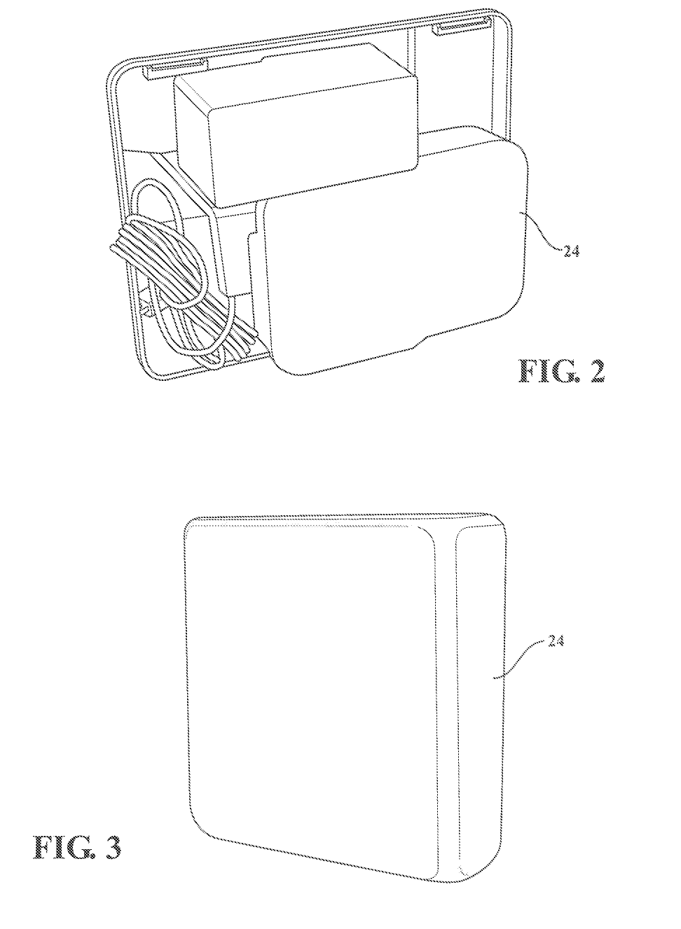

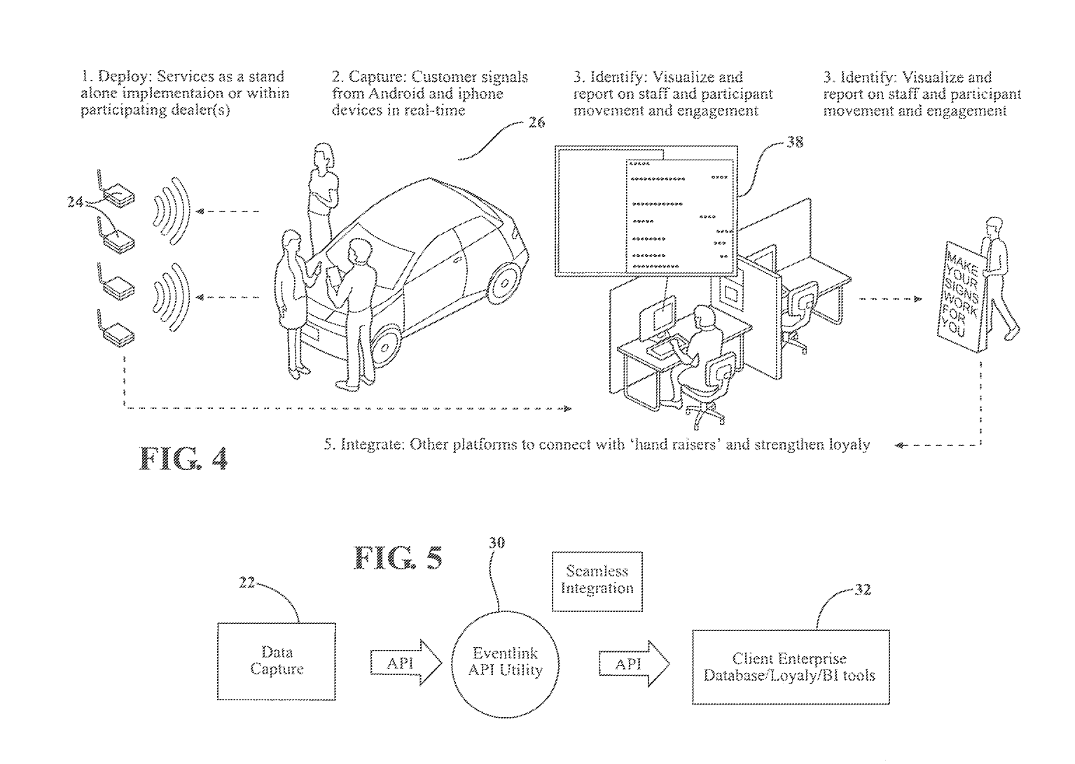

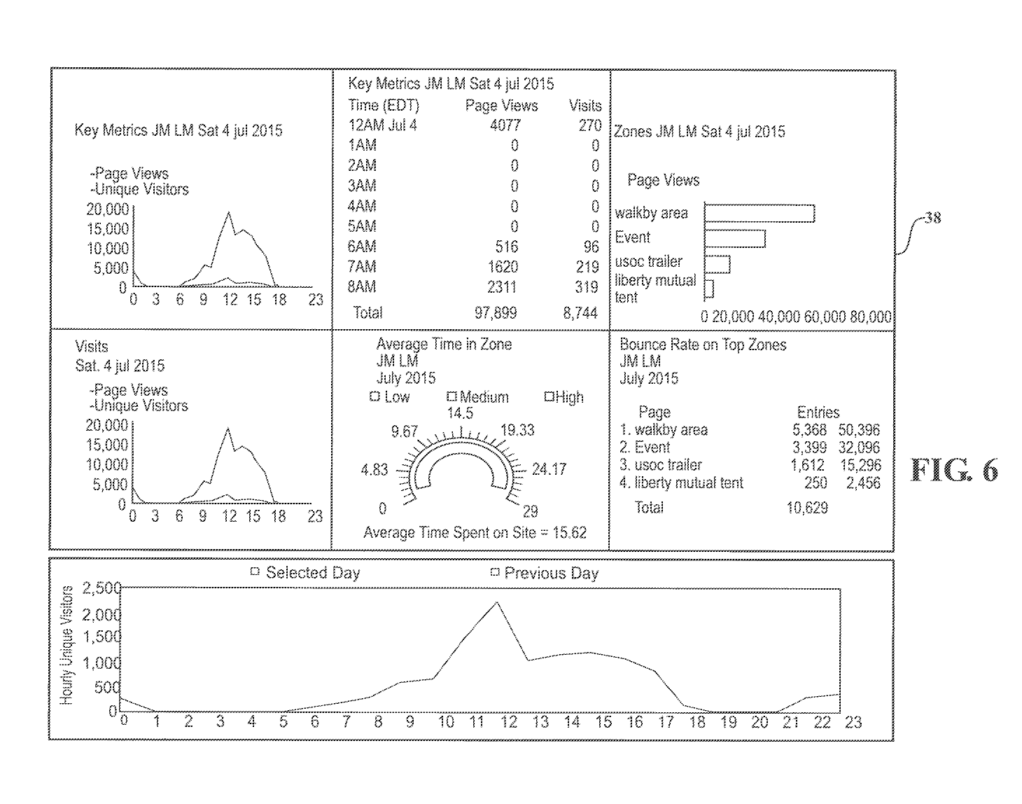

According to an aspect, the data collection subsystem 22 can include a plurality of wireless access points 24 (FIGS. 2 and 3), disposed in a spaced relationship with one another around the predetermined area 26 (e.g., a trade show, or vehicle showroom) as shown in FIG. 4. According to an aspect, the wireless access points 24 may be geographically spaced from one another. According to another aspect, the wireless access points 24 may be self-powered and may be connected to an internet connection from a hard line, wireless, or mobile data provider, for example. By using an array of spaced wireless access points 24 (e.g., geographically spaced), the wireless access points 24 may provide the ability to triangulate a precise geographic location of each mobile device 28. The locations of each mobile device 28 can be captured as a function of time (i.e., the location data is stored with timestamps). According to an aspect of the disclosure, the mobile devices 28 location may also be determined from the use of a global positioning system (GPS).

As illustrated in FIG. 5, the processing system may include and utilize a plurality of application programming interfaces (API) to facilitate the flow of data (e.g., mobile traffic information, website traffic information, and foot traffic information) from the data collection subsystem 22 through the processing subsystem 30 to the storage subsystem 32. The processing subsystem 30 may comprise a single processing unit, but it should be understood that the processing subsystem 30 may be remotely located or distributed over many processing units and the processing may be carried out by third party services as well, such as, but not limited to Google Analytics, Adobe Analytics, SAP Analytics, or IBM Cognos according to another aspect.

According to an aspect, the storage subsystem 32 may include a variety of storage devices including internal memory and external mass storage typically arranged in a hierarchy of storage as understood by those skilled in the art. For example, the storage susbsystem may include random access memory (“RAM”), read-only memory (“ROM”), flash memory, and/or disk devices. The storage subsystem 32 may also include at least one database 34 for storing data from the data collection subsystem 22 and/or from the processing subsystem 30.

The analytic data capturing and processing system 20 may also include an output subsystem 36 coupled to the processing subsystem 30. As best shown in FIG, 6, the output subsystem 36 may include a display 38 to provide the data (e.g., mobile traffic information, website traffic information, and foot traffic information) in a dashboard type format. Alternatively, the output subsystem 36 may transmit or transfer data from the storage subsystem 32 to another system for further processing and analysis or for remote presentation or remote analysis. According to an aspect of the disclosure, the output subsystem 36 may also include a network interface 40 (FIG. 1) capable of communicating over a wired and/or a wireless network.

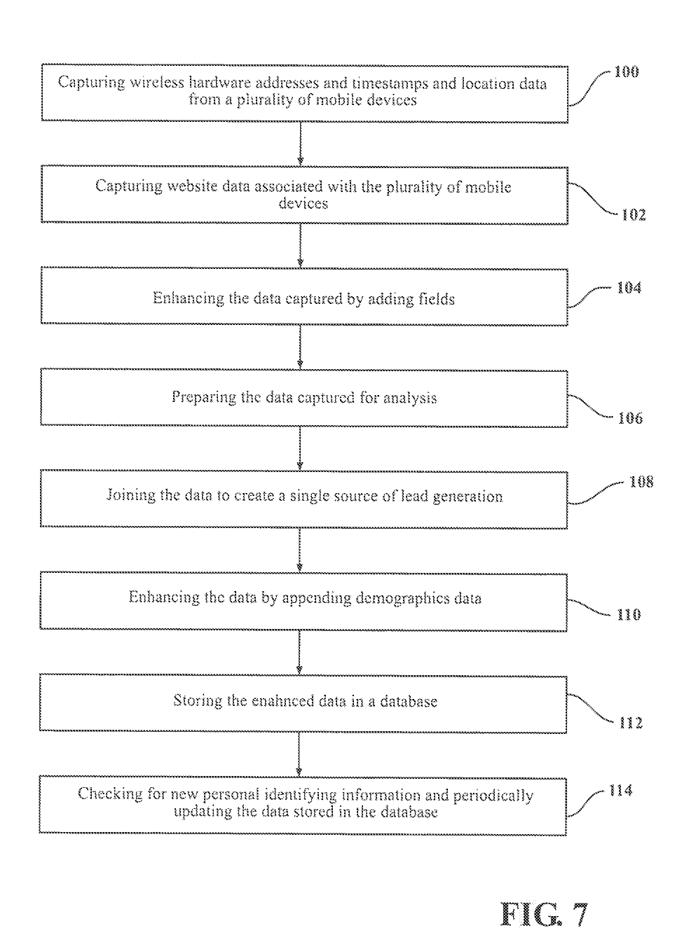

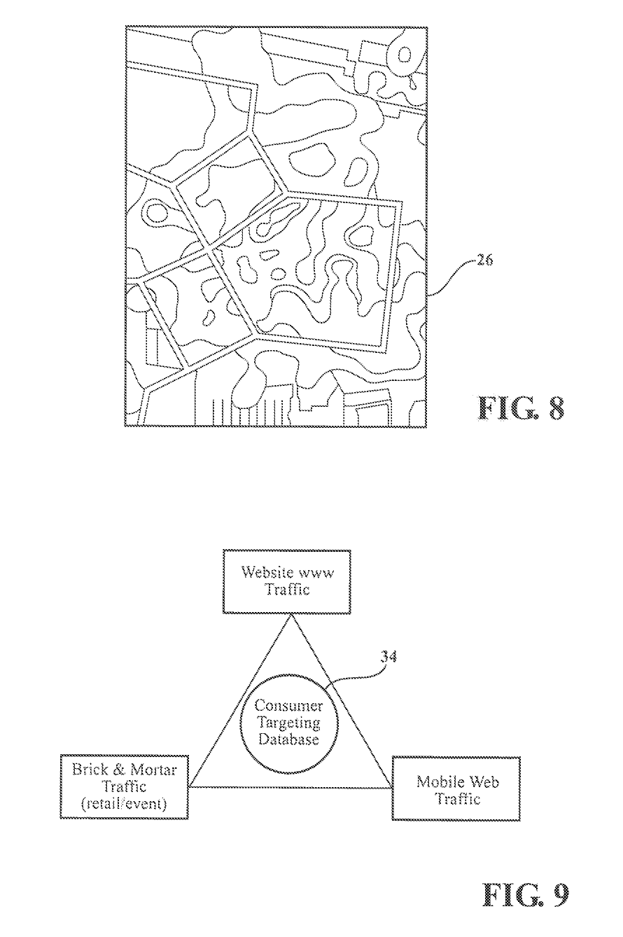

As shown in FIG. 7, a method of capturing and processing analytic data is also disclosed and may include the step of 100 capturing wireless hardware addresses and timestamps and location data from a plurality of mobile devices 28. According to an aspect, the wireless hardware address may be a Wi-Fi Media Access Control (MAC). Because mobile devices 28 equipped with Wi-Fi frequently broadcast their MAC addresses periodically in an effort to locate and connect to Wi-Fi access points, the method does not require users to opt in or provide permission. The data including location and timestamps may then be visualized in real-time to indicate traffic concentration and dwell times (e.g. using the display 38 of the output subsystem 36). Consequently, optimal asset and signage placement and validation of change effectiveness may be revealed. According to another aspect, interne protocol (IP) addresses may also be captured in addition to or in place of MAC addresses. The step of 100 capturing wireless hardware addresses and timestamps and location data may additionally or alternatively utilize other wireless technologies such as, but not limited to Bluetooth and Near Field Communication (NFC) rather than Wi-Fi. According to an aspect, the data can be scrubbed and cleansed to remove identifying information except MAC addresses. The data then may be segmented into overlaid geo-fenced areas (FIG. 8).

The method proceeds by 102 capturing website data associated with the plurality of mobile devices 28. The website data captured may include on-site website data, in other words, data which tracks a visitor's actions and behavior on a specific website operated by a company utilizing the disclosed method of capturing and processing analytic data. According to an aspect of the disclosure, the on-site website data is captured or collected using a commercial web analytics service, such as, but not limited to Google Analytics. According to another aspect, the on-site web data collection could also or additionally include server log file analysis, page tagging data collection (e.g. JavaScript page tagging), Hypertext Transfer Protocol (HTTP) cookies, HTTP referrer, image tags, or some combination of these data collection methods.

The website data captured may also include off-site website data, or data that is captured from the mobile device 28 corresponding to websites visited that are not operated by the company utilizing the disclosed method of capturing and processing analytic data (i.e. other websites, such as marketplace competitors or subsidiary corporations). According to an aspect of the disclosure, the off-site data capture also can include capturing wireless network data packets (i.e. packet sniffing) using a computing device with a wireless adapter capable of monitoring all wireless network traffic. More specifically, all packets transmitted by the mobile device 28 to another computing device (e.g. server, gateway, etc.) can be captured and may be analyzed without requiring javaScript, HTTP cookies, or server logs.

The next step of the method is 104 enhancing the data captured by adding fields. Available identification is associated with each data set identified by an IP address, MAC address or other initial identifier. To this, other data such as, but not limited to first name, last name, email, mobile phone number, home phone number, street address, city, state, and zip code may also be added if available. Additionally, the data may be ranked and a lead percentage may be calculated and added to the data. In other words, the plurality of leads associated with the captured data (e.g., wireless hardware addresses, timestamps, location data, and website data from the plurality of mobile devices 28) can be tracked into the database 34 and a scoring mechanism may be used for ranking the plurality of leads.

The method continues by 106 preparing the data for analysis. As mentioned above, commercial tools or third party analytics packages such as Google Analytics for example may be used to provision or track, organize, analyze, and report (e.g., visualization of the captured data). Other commercial tools used for this step include Adobe Analytics, SAP Analytics, or IBM Cognos for example. Generally these tools require that the data be input to them in a specific format which may vary according to the tool being utilized, therefore the data may need to be formatted.

The next step of the method is 108 joining the data to create a single source of lead generation. More specifically, in this step, captured MAC addresses, IP addresses, any personal identifying information (e.g. name, address, city, state, postal code, etc.) may be joined with the captured MAC addresses. Based on the available data, a score percentage can be calculated.

Next, the method includes the step of 110 enhancing the data by appending demographics data. According to an aspect of the disclosure, the data may be enhanced with data from sources such as, but not limited to the U.S. Census, Claritas, Equifax, Experian, TransUnion, and ESRI.

The method continues with the step of 112 storing the enhanced data in a database 34. The enhanced data advantageously may then be used to strengthen loyalty and provide better insight into the customer's journey and decision-making processes. Because the data includes location and movement data, mobile web traffic, and website traffic, the method of capturing and processing analytic data disclosed uniquely aligns corresponding information concerning mobile traffic, website traffic, and foot traffic (FIG. 9) since the data includes location and timestamp data, and on-site and off-site website data.

The method concludes with the step of 114 checking for new personal identifying information and periodically updating the data stored in the database 34. According to an aspect of the disclosure, the step of checking for new personal identifying information and updating the data may occur every four hours, but it should be appreciated that the analytic data capturing and processing system 20 may check for new personal identifying information and update the data store in the database 34 at any predetermined interval.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. Those skilled in the art will recognize that concepts disclosed in association with an example switching system can likewise be implemented into many other systems to control one or more operations and/or functions.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.), As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

Obviously, many modifications and variations of the present disclosure are possible in light of the above teachings and may be practiced otherwise than as specifically described while within the scope of the appended claims.

What is claimed is:

1. An analytic data capturing and processing system comprising:
a data collection subsystem including at least one wireless access point for capturing wireless hardware addresses and timestamps and location data from a plurality of mobile devices;
a processing subsystem coupled to said data collection subsystem;
a storage subsystem coupled to said data collection subsystem and to said processing subsystem and including at least one database for storing data from at least one of said data collection subsystem and said processing subsystem;
said data collection subsystem configured to capture website data associated with the plurality of mobile devices; and
said processing subsystem configured to scrub and analyze the wireless hardware addresses and timestamps and location data and website data captured to align mobile traffic information and website traffic information and foot traffic information.

2. An analytic data capturing and processing system as set forth in claim 1, wherein said at least one wireless access point includes a plurality of wireless access points disposed in a paced relationship with one another around a predetermined area.

3. An analytic data capturing and processing system as set forth in claim 1, further including an output subsystem coupled to said processing subsystem and including a display to provide at least one of mobile traffic information and website traffic information and foot traffic information to a user.

4. An analytic data capturing and processing system as set forth in claim 1, wherein the mobile traffic information and website traffic information and foot traffic information include at least one of number of total and new and unique attendees and event zoning and aggregate analytics and average zone dwell time spent and zone engagement and conversion rates and attendance rate and event loyalty rate and total number of impressions and event geography and quality of event staff and participation and time of year and time of day and event site plan analysis.

5. An analytic data capturing and processing system as set forth in claim 1, wherein said processing subsystem is further configured to segment the wireless hardware addresses and timestamps and location data and website data into overlaid geofenced areas.

6. An analytic data capturing and processing system as set forth in claim 1, wherein said processing subsystem is further configured to provision the wireless hardware addresses and timestamps and location data and website data into a third party analytics package.

7. An analytic data capturing and processing system as set forth in claim 1, wherein said processing system includes a plurality of application programming interfaces to facilitate a flow of data from said data collection subsystem through said processing subsystem to said storage subsystem.

8. An analytic data capturing and processing system as set forth in claim 1, wherein said output subsystem includes a network interface capable of communicating over at least one of a wired and a wireless network to transfer data from said storage subsystem to another system for at least one of further processing and remote analysis and remote presentation.

9. A method of capturing and processing analytic data comprising the steps of:
capturing wireless hardware addresses and timestamps and location data from a plurality of mobile devices;
capturing website data associated with the plurality of mobile devices;
enhancing the data captured by adding fields;
preparing the data for analysis;
joining the data to create a single source of lead generation;
enhancing the data by appending demographics data; and
storing the enhanced data in a database.

10. A method as set forth in claim 9, further including the step of checking for new personal identifying information and periodically updating the data stored in the database.

11. A method as set forth in claim 10, wherein the step of checking for new personal identifying information and periodically updating the data stored in the database is further defined as checking for new personal identifying information and periodically updating the data stored in the database at a predetermined interval.

17. A method as set forth in claim 9, further including the step of ranking a plurality of leads corresponding with the captured data using a scoring mechanism.

13. A method as set forth in claim 9, further including the step of displaying location and timestamps in real-time to indicate traffic concentration and dwell times.

14. A method as set forth in claim 9, further including the step of removing identifying information.

15. A method as set forth in claim 9, further including segmenting the data into overlaid geofenced areas.

16. A method as set forth in claim 9, wherein the step of capturing website data associated with the plurality of mobile devices is further defined as capturing on-site website data associated with the plurality of mobile devices.

17. A method as set forth in claim 16, wherein the on-site web data is collected using a commercial web analytics service. 18, A method as set forth in claim 16, wherein the on-site web data includes at least one of server log file analysis and page tagging data collection and HTTP cookies and HTTP referrer and image tags.

19. A method as set forth in claim 9, wherein the step of capturing website data associated with the plurality of mobile devices includes sniffing wireless packets.

90. A method as set forth in claim 9, wherein the step of joining the data to create a single source of lead generation includes joining personal identifying information with the captured data.
